(19) United States
(12) Patent Application Publication
(10) Pub. No.: US 2010/0026503 A1
(43) Pub. Date: Feb. 4, 2010

(54) VEHICLE LOCATING DEVICE AND METHOD

(75) Inventors: DAVID T. PROEFKE, MADISON HEIGHTS, MI (US); CLARK E. McCALL, ANN ARBOR, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/185,271

(22) Filed: Aug. 4, 2008

(51) Int. Cl. G01W 1/02

(52) U.S. Cl. 340/601

(57) ABSTRACT

A system for determining the difference in altitude between a vehicle and a portable electronic device is provided. The system comprises a first pressure sensor, a second pressure sensor, and a processor. The first pressure sensor is coupled to the portable electronic device and generates a first signal indicative of the atmospheric pressure at the portable electronic device. The second pressure sensor is coupled to the vehicle and generates a second signal indicative of the atmospheric pressure at the vehicle. The processor is coupled between the vehicle and the portable electronic device and is configured to receive the first signal and determine a first pressure altitude therefrom, and receive the second signal and determine a second pressure altitude therefrom.

### TECHNICAL FIELD

The present invention generally relates to an apparatus and method for locating a vehicle and, more particularly, to an apparatus and method for determining the difference in altitude between a user and a parked vehicle.

### BACKGROUND OF THE INVENTION

At one time or another, most vehicle owners have experienced difficulty in locating a vehicle they had previously parked. This problem can be particularly vexing when the vehicle is located in an expansive parking area of the type commonly found at large venues such as malls, airports, or sports arenas. To overcome this problem, some parking garages contain a localized wireless network that communicates with a vehicle locating system to establish way points and provide directional guidance to a driver. However, these systems do not determine a vehicle's relative altitude and therefore, where multi-level structures are used, do not solve the more fundamental quandary of determining the correct level to search.

Thus, there exists the need to provide a system to assist a driver with information relating to the difference in altitude between themselves and a misplaced vehicle when it is parked in either a tiered parking structure or in a hilly or mountainous region. Further, it would be desirable if such a system were integrated into an existing electronic device of the type typically carried by a driver, such as a keyfob. Other desirable features and characteristics of the present invention will become apparent from the subsequent detailed description and the appended claims, taken in conjunction with the accompanying drawings and the foregoing technical field and background.

### SUMMARY OF THE INVENTION

In accordance with an embodiment, by way of example only, a system for determining the difference in altitude between a vehicle and a portable electronic device is provided. The system comprises a first pressure sensor, a second pressure sensor, and a processor. The first pressure sensor is coupled to the portable electronic device and generates a first signal indicative of the atmospheric pressure at the portable electronic device. The second pressure sensor is coupled to the vehicle and generates a second signal indicative of the atmospheric pressure at the vehicle. The processor is coupled between the vehicle and the portable electronic device and is configured to receive the first signal and determine a first pressure altitude therefrom, and receive the second signal and determine a second pressure altitude therefrom.

A method for determining the difference in altitude between a portable electronic device and a vehicle in accordance with an exemplary embodiment of the present invention is provided. The method comprises sensing a first atmospheric pressure at the portable electronic device using a first pressure sensor, determining a first pressure altitude based upon the first atmospheric pressure, sensing a second atmospheric pressure at the vehicle using a second pressure sensor, and determining a second pressure altitude based upon the second atmospheric pressure.

### DESCRIPTION OF THE DRAWINGS

The present invention will hereinafter be described in conjunction with the following drawing figures, wherein like numerals denote like elements, and:

FIG. 1 is a plan view of a keyfob having a parked vehicle location function in accordance with a first exemplary embodiment;

FIG. 2 is schematic diagram of a multi-tiered parking structure of the type used to describe an exemplary embodiment;

FIG. 3 is a block diagram of a vehicular altitude differential determining system that may be incorporated into an electronic device such as the keyfob shown in FIG. 1;

FIG. 4 is a process flow diagram of a method for calibrating a vehicular altitude differential determining system in accordance with an exemplary embodiment; and

FIG. 5 is a process flow diagram of a method for determining the altitude differential of a vehicle in accordance with an exemplary embodiment.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

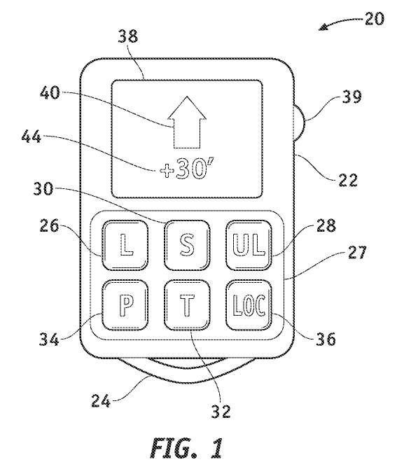

FIG. 1 is a plan view of a keyfob 20 commonly used by a driver for wireless activation of a set of vehicle functions or “features.” In accordance with a first exemplary embodiment, these features include wireless activation of a system for locating a parked vehicle including its relative altitude with respect to a user. Keyfob 20 comprises a housing 22 having a fixture 24 that enables conventional attachment of keyfob 20 to a key ring or chain. A keypad 27 comprises a plurality of buttons for interfacing a set of vehicle features and may include, for example, a door lock (L) button 26, a door unlock (UL) button 28, a remote start (S) button 30, a trunk unlock (T) button 32, a panic (P) button 34, and a vehicle locate (LOC) button 36. Keyfob 20 further comprises a display 38 (e.g., a liquid crystal display) that may visually provide a user with information relating to a vehicle (or vehicles) associated with keyfob 20. This information may include the vehicle's mileage, tire pressure, current fuel level, radio station settings, door lock status, and the like. A scroll wheel 39 may be mounted on a side of housing 22 and utilized to peruse such data. For example, a user may rotate scroll wheel 39 to navigate between vehicular features and depress scroll wheel 39 to select a desired feature and view status information associated therewith.

When a user depresses the LOC button 36, keyfob 20 may provide visual prompts on display 38 that may guide the user back to his or her parked vehicle. For example, as indicated in FIG. 1, a directional indicator such as an arrow 40 may be generated on display 38 indicating that a vertical distance or difference in altitude 44 (depicted as 30′) exists between the vehicle and a user holding the keyfob determined in a manner to be described in detail below. The difference in altitude 44 may be expressed in appropriate units such as feet or meters adjacent to a plus (+) or minus (−) sign to indicate whether the vehicle is above or below the keyfob. This example notwithstanding, it should be appreciated that other embodiments of keyfob 20 may utilize different visual indicators to guide a user back to the vehicle. In still other embodiments, keyfob 20 may produce audible signals in addition to, or in lieu of, visual signals.

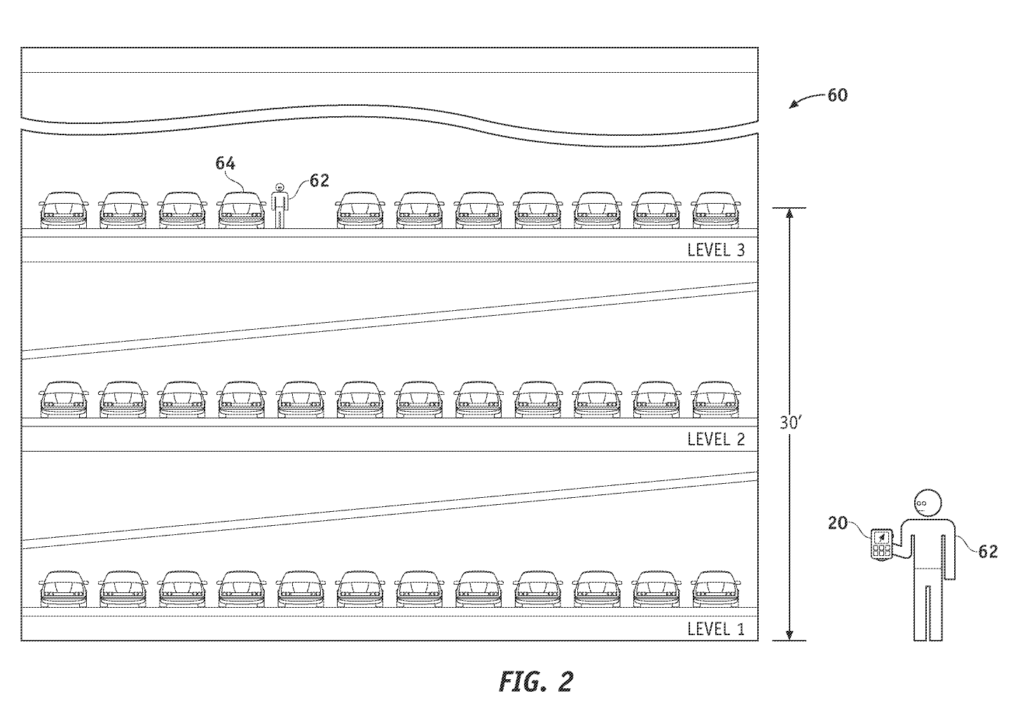

FIG. 2 illustrates a typical multi-tiered parking structure 60 constructed with three levels and having a plurality of vehicles parked therein. A vehicle 64 is illustrated as having been parked on the 3^{rd} level of parking structure 60 by a driver 62. Driver 62 is also illustrated at a time subsequent to parking vehicle 64 standing at ground level (level 1) of structure 60 and, as depicted, is seeking to locate/retrieve vehicle 64. Driver 62 carries a hand-held electronic device such as keyfob 20 illustrated in FIG. 1 in accord with an exemplary embodiment which interacts with sensors in vehicle 64 to provide directional and/or displacement information relating to the location of vehicle 64. In an embodiment, this information includes the difference in altitude between parked vehicle 64 located on level 3 and keyfob 20 in a driver's possession at level 1. Driver 62 may use the altitude differential information to assist in determining the level of parking structure 60 on which vehicle 64 is parked.

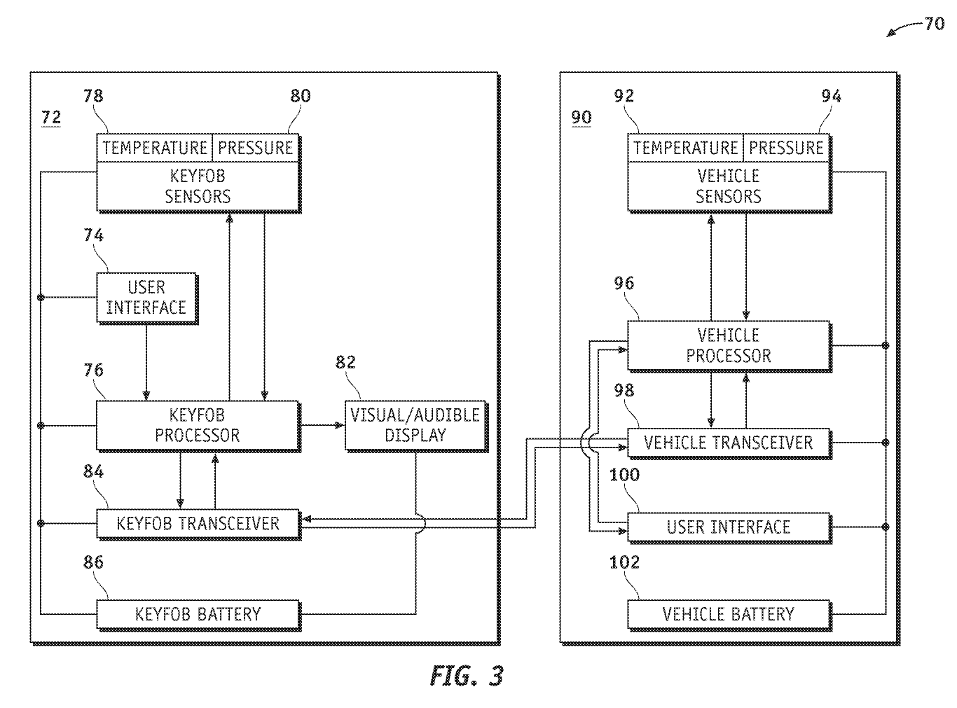

FIG. 3 is a block diagram of a system 70 for determining a difference in altitude in accordance with an embodiment. System 70 comprises a keyfob subsystem 72 implemented in a portable electronic device, and a vehicle subsystem 90 implemented into a vehicle. While subsystem 72 may be incorporated into a variety of portable devices such as a mobile phone, a digital watch, a digital audio file player (e.g., an MP3 or MP4 player) or a personal digital assistant (PDA), it will be hereinafter described as being implemented into a portable keyfob device of the type shown in FIG. 1.

Keyfob subsystem 72 comprises a processor 76 operatively coupled to a user interface 74, a temperature sensor 78, a pressure sensor 80, a visual and/or audible display 82, a transceiver 84, and a battery 86 to power to each component. Processor 76 is configured to receive user commands to activate vehicle features sent via interface 74, and is connected in two-way communication with transceiver 84 whereby data (such as user commands) may be sent to vehicle subsystem 92, or conversely, data (such as relating to vehicle status) may be received therefrom. Temperature sensor 78 and pressure sensor 80 are configured to gather temperature and pressure data on command from a user, and relay this information to processor 76. As will be described in greater detail below, processor 76 may use these data to calculate a difference in altitude between a user and a vehicle, and communicate the result through display 82.

Vehicle subsystem 90 comprises a processor 96 operatively coupled to temperature 92 and pressure 94 sensors, a transceiver 98, a user interface 100, and a battery 102 to provide power to each component. That is, processor 96 engages in two-way communication with transceiver 98 to both send information (such as vehicle status) and receive information (such as user commands to activate vehicle features) from keyfob system 72. In one embodiment, keyfob processor 76 may activate temperature sensor 92 and pressure sensor 94, and receive data therefrom relating to the temperature and pressure within the vehicle. In another embodiment, user interface 100 may be used to activate temperature and pressure sensors 78 and 80 respectively in keyfob system 72. In this case, the activating signal is sent through vehicle processor 96 to transceiver 98 where it is transmitted to keyfob system 72. Keyfob temperature and pressure sensors 78 and 80 respectively record ambient conditions at the keyfob and transfer these data to either keyfob processor 76 or vehicle processor 96 depending on which processor is configured to receive/manipulate such data.

System 70 determines the difference in altitude between a keyfob and a vehicle by measuring the atmospheric pressure in both locations at substantially the same time, converting each atmospheric pressure reading to a pressure altitude, and determining the difference in altitude as the difference between the keyfob and vehicle pressure altitudes. A pressure altitude is the altitude that corresponds to a measured atmospheric pressure relative to a reference altitude and pressure. The reference conditions typically used are based upon sea level conditions and comprise an altitude of zero feet, and an atmospheric pressure of 1013.25 millibars. While a sea level-based reference has been herein described, other reference conditions may also be used provided that pressure altitudes for points of interest are determined using the same reference. System 70 uses pressure sensors 80 and 94 disposed in a keyfob and vehicle respectively for atmospheric pressure measurement. Each of these measurements is then converted to a pressure altitude in a manner described in detail below. These data are supplemented with concurrently recorded temperature data using companion temperature sensors 78 and 92 embedded into keyfob and vehicle circuits respectively. Because the reading taken by pressure sensors may be affected by the wide temperature variability typical of the interior of a parked vehicle and/or a portable keyfob, temperature data taken concurrently is used to adjust (correct) the pressure measurements accordingly.

Calculation of pressure altitude from atmospheric pressure data may be done using any suitable algorithm including a look-up table comprised of empirically generated data. Mathematical formulae that correlate pressure altitude as a function of measured atmospheric pressure are well known, and may be conveniently programmed into a processor tasked with calculating the final difference in altitude. For example, Equation (1) represents an exemplary formula for determining the pressure altitude h_{Y} relative to the sea level reference altitude and pressure (zero feet and 1013.25 millibars), of a point Y where the atmospheric pressure, P_{Y}, is known:

$${h}_{Y} = [ 1 - {( \frac{{P}_{Y}}{1013.25} )}^{0.190284} ] \times 145366.45 \qquad Equation ( 1 )$$

wherein h_{Y} and P_{Y} are expressed in feet and millibars respectively. Equation (1) may be rearranged to provide equation (2) that can be used for determining the difference in pressure altitude between a vehicle and a keyfob when the ambient atmospheric pressure for each is known:

$$Δ A = {h}_{vehicle} - {h}_{fob} = 38951.5196 ⌊ {P}_{fob}^{0.190284} - {P}_{vehicle}^{0.190284} ⌋ \qquad Equation ( 2 )$$

wherein ΔA, the difference in pressure altitude, h_{vehicle}, the pressure altitude of the vehicle, and h_{fob}, the pressure altitude of the keyfob, are each expressed in feet, and P_{fob} and P_{vehicle}, the ambient atmospheric pressures at the keyfob and vehicle respectively, are expressed in millibars. In this example, the result ΔA provides an estimate of the difference in altitude between the vehicle and the keyfob.

Pressure and temperature sensors for vehicular systems should be small in size to be integratable into a keyfob, and have low power requirements to provide long battery life. Pressure sensors may also be sensitive to minute pressure differentials characteristic of the relatively small altitude differentials applicable to parking structures. Sensors based upon microelectromechanical systems (MEMS) or semiconductor technology have these attributes and thus may be useful in vehicular applications. Other systems applicable as pressure sensors include those based on variable capacitance or vibrating elements. However, the output signals from pressure sensors may be distorted by temperature variations typical for vehicular applications, leading to erroneous results. Pressure signals may be corrected for temperature effects by applying appropriate experimentally determined temperature-compensation factors. Because each pressure sensor may be affected differently, temperature correction factors unique to the sensor may be required.

In one embodiment, a pressure sensor is accompanied by a separate temperature sensor for generating signals indicative of ambient pressure and temperature. A processor coupled to both sensors receives these signals, and determines a temperature-corrected pressure. Separate temperature sensors may be based, for example, upon a temperature sensitive element such as a thermister integrated into a supporting circuit such as a Wheatstone Bridge. Temperature sensitive elements may also include but are not limited to thermocouples and resistive temperature detectors (RTDs) and, along with their supporting circuitry, are well known to those skilled in the art. In a further embodiment, a processor receiving separate pressure and temperature signals may determine temperature compensation using a look-up table comprised of empirically generated data, or by using a mathematical formula based upon such data.

In another embodiment, pressure and temperature sensors are combined into the same device to provide a single output pressure signal that has been internally temperature compensated. One example of a commercially available pressure sensor of this type is manufactured by Freescale Semiconductor bearing part number MP3H6115A. This device is a piezorestive transducer that utilizes thin film resistor networks coupled with silicon semiconductor processing to provide a temperature-compensated signal proportional to applied pressure. The output pressure signal is pre-calibrated over a temperature range of from −40 to 125° C. and provides a signal having a 1.5% maximum error when used from 0 to 85° C. Data processing is thereby simplified by eliminating the need to separately compensate for temperature effects.

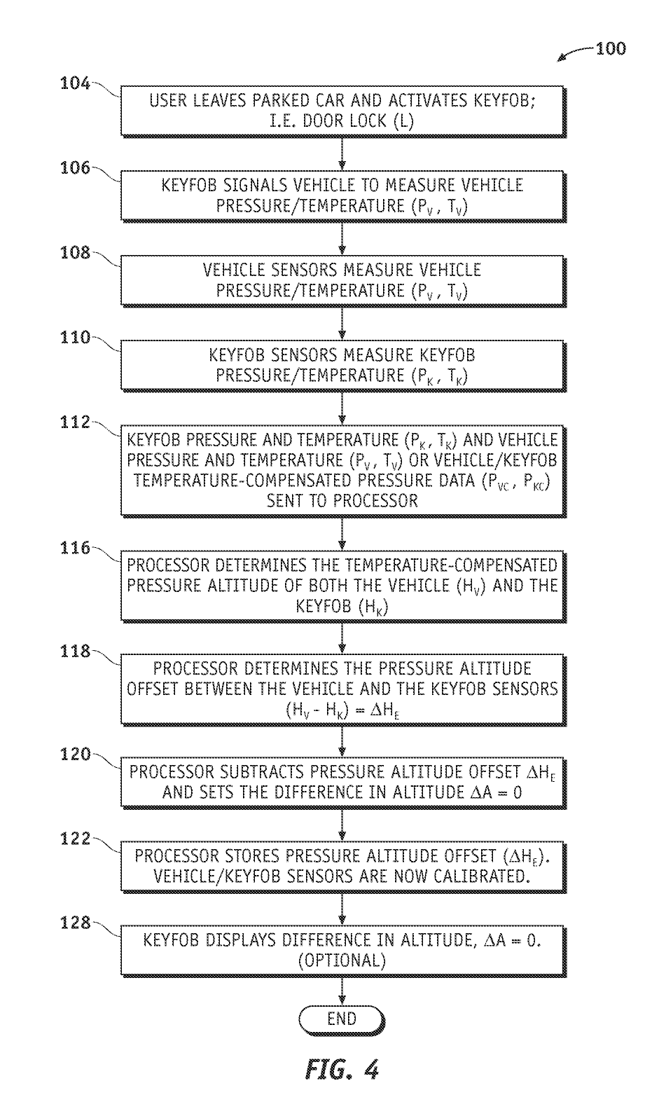

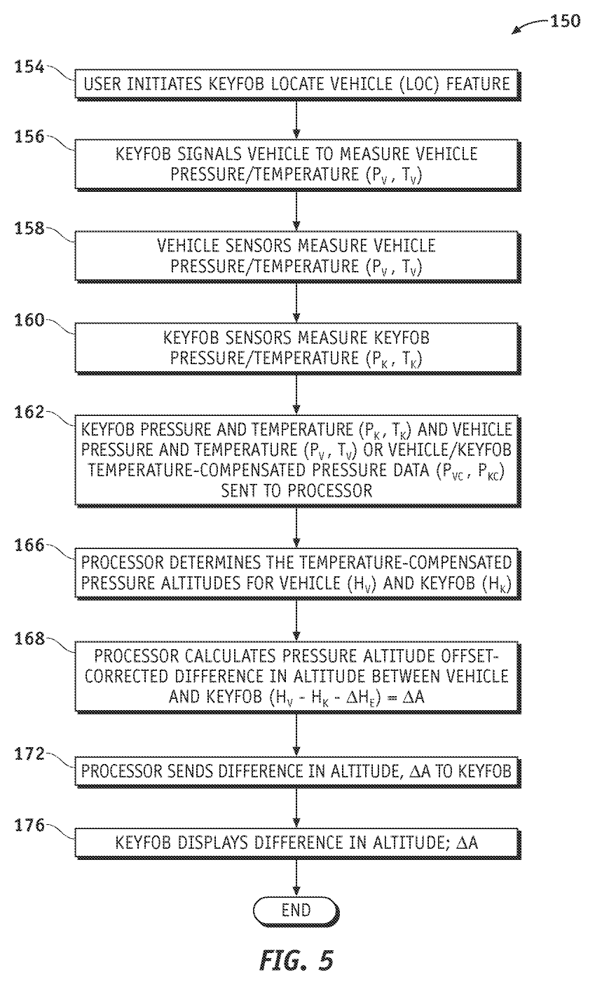

In accordance with an exemplary embodiment, FIGS. 4 and 5 are process flow diagrams that may be used in conjunction to estimate the difference in altitude of a vehicle parked in a multi-tiered structure or in hilly terrain relative to a driver. A procedure 100 for self-calibration of system 70 (FIG. 3) is illustrated in FIG. 4, and is typically performed by the keyfob and vehicle when both are at substantially the same altitude such as when the vehicle is first parked, and thereby are subject to substantially the same atmospheric pressures. Procedure 100 is configured to determine sensor-to-sensor measurement discrepancy, and convert this difference to a pressure altitude offset, between keyfob and vehicle pressure sensors that would potentially add error to the final result. Procedure 150, illustrated in FIG. 5, estimates the difference in altitude between a keyfob and a vehicle compensating for pressure altitude offset, and is used subsequent to procedure 100 to assist a user in locating the vehicle.

FIG. 4 is a process flow diagram illustrating self-calibration procedure 100 in accordance with an exemplary embodiment. Procedure 100 begins when a driver uses a keyfob to initiate a vehicle feature consistent with parking a vehicle such as the door lock (L) 26 button on keyfob 20 (step 104). While locking the door is one possible means of initiating self-calibration procedure 100, it should be understood that other vehicle features consistent with parking a vehicle may activate this procedure. These include but are not limited to turning the engine ignition off, placing the vehicle in park, engaging the emergency brake system, and the like. When the user initiates activation (step 104), the keyfob transceiver sends a wireless signal through the vehicle transceiver to the vehicle processor to activate sensors to measure the pressure and temperature within the vehicle (step 106). Vehicle sensors then take pressure and temperature readings in the vehicle (P_{V}, T_{V}) (step 108) while, at substantially the same time keyfob sensors take analogous measurements of pressure and temperature (P_{K}, T_{K}) of keyfob ambient in step 110.

In one exemplary embodiment, the vehicle processor 96 (FIG. 3) is configured to process pressure and temperature data. In this embodiment, the vehicle processor receives keyfob pressure and temperature (P_{K}, T_{K}) data via wireless transmission from the keyfob, and like vehicle data, (P_{V}, T_{V}), from the vehicle pressure and temperature sensors (step 112). In a further embodiment, pressure data may be automatically compensated for temperature by the pressure sensor itself as previously described, and thereby only pressure data from the vehicle and keyfob (P_{VC}, P_{KC}) is sent to the vehicle processor. In either case, the processor uses these data to determine the temperature-compensated pressure altitude of the vehicle (H_{V}) and the keyfob (H_{K}) (step 116) by using, for example, Equation (1) described above. In step 118, the difference or pressure altitude offset, ΔH_{E}, is determined by subtracting the keyfob pressure altitude from the vehicle pressure altitude. As previously described, when readings are taken at substantially the same altitude, and at substantially the same time, a non-zero pressure altitude offset is attributable to a measurement discrepancy between the keyfob and vehicle sensors. In step 120, the pressure altitude offset (ΔH_{E}) is subtracted, effectively setting the resultant difference in altitude, ΔA, equal to zero. As will be described in greater detail below, the pressure altitude offset, ΔH_{E}, is stored (step 122) as a correction factor to be used in procedure 150 when the next vehicle locate request is made by a user. Finally, in an optional embodiment (step 128), the vehicle transceiver communicates to the keyfob transceiver the completed status of self-calibration procedure 100 and/or that the difference in altitude, ΔA is equal to zero, both of which may be displayed to a driver on display 38 (FIG. 1).

Alternatively, in another exemplary embodiment, the keyfob processor 76 (FIG. 3) is configured to determine the difference in altitude. The processing steps from the previous embodiments are identically followed except that pressure and temperature signals from the vehicle (P_{V}, T_{V}), and keyfob (P_{K}, T_{K}), or alternatively, temperature-compensated pressure signals from the vehicle and keyfob (P_{VC}, P_{KC}), are sent to the keyfob processor. In step 116, the keyfob processor uses these data to determine temperature-compensated pressure altitudes for both vehicle (H_{V}) and keyfob (H_{K}). In step 118, the processor determines the pressure altitude offset, ΔH_{E}, by subtracting keyfob pressure altitude (H_{K}) from vehicle pressure altitude (H_{V}). As previously described, the difference in altitude, ΔA, is set equal to zero (step 120), and the pressure altitude offset, ΔH_{E}, is stored (step 122) for use as a correction factor for subsequent locate-vehicle commands. In an optional embodiment (step 128), the keyfob may display the difference in altitude (ΔA=0) and/or the completed status of self-calibration process 100 to the user on its display.

FIG. 5 is a process flow diagram illustrating a procedure 150 that may be used by a driver wishing to locate a vehicle. Procedure 150 begins at step 154 when the driver initiates the locate vehicle (LOC) 36 feature using keyfob 20 shown in FIG. 1. The keyfob transceiver transmits a wireless request to the vehicle transceiver to activate vehicle sensors to measure vehicle pressure and temperature (P_{V}, T_{V}) (step 156). Vehicle sensors respond by sampling vehicle pressure and temperature P_{V} and T_{V} (step 158) substantially simultaneously with keyfob sensors that record analogous keyfob data (P_{K} and T_{K}) in step 160.

In accordance with an exemplary embodiment, keyfob pressure and temperature (P_{K} and T_{K}) and vehicle pressure and temperature (P_{V} and T_{V}) data, or temperature-compensated pressure data (P_{VC}, P_{KC}) from each are sent to the vehicle processor (step 162). In step 166, the processor determines temperature-compensated pressure altitudes for the vehicle (H_{V}) and keyfob (H_{K}) using these data in conjunction with an appropriate algorithm such as Equation 1. In step 168, the vehicle processor subtracts the keyfob pressure altitude (H_{K}) and the pressure altitude offset (ΔH_{E}) stored from procedure 100, from the vehicle pressure altitude (H_{V}) to determine the difference in altitude, ΔA, between vehicle and keyfob corrected for pressure altitude offset. In step 172, ΔA is transferred to the keyfob where it is displayed to a driver in appropriate units on display 38 (FIG. 1).

In a further exemplary embodiment, the keyfob processor is configured to determine the difference in altitude from pressure and temperature data. In this embodiment, vehicle and keyfob pressure and temperature data (P_{V} and T_{V}) and (P_{K} and T_{K}) respectively, or temperature-compensated pressure data (P_{VC}, P_{KC}) from each are routed to the keyfob processor in step 162. In step 166, the keyfob processor uses these data in conjunction with an appropriate algorithm such as Equation 1 to determine temperature-compensated pressure altitudes for the vehicle (H_{V}) and keyfob (H_{K}). In step 168, the processor subtracts the keyfob pressure altitude (H_{K}) and the pressure altitude offset (ΔH_{E}) from the vehicle pressure altitude (H_{V}) to determine the difference in altitude (ΔA) between vehicle and keyfob corrected for pressure altitude offset. In step 176, the processor relays this result to display 38 (FIG. 1) to provide assistance to the driver in determining which level of a multi-tiered structure a vehicle is parked on.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system for determining the difference in altitude between a vehicle and a portable electronic device, the system comprising:
a first pressure sensor coupled to the portable electronic device for generating a first signal indicative of the atmospheric pressure at the portable electronic device;
a second pressure sensor coupled to the vehicle for generating a second signal indicative of the atmospheric pressure at the vehicle; and
a processor coupled between the vehicle and the portable electronic device configured to receive the first signal and determine a first pressure altitude therefrom, and to receive the second signal and determine a second pressure altitude therefrom.

2. The system of claim 1, wherein the processor is further configured to determine the difference in altitude between the vehicle and the portable electronic device based upon the first pressure altitude and the second pressure altitude.

3. The system of claim 2, further comprising a display coupled to the portable electronic device for displaying the difference in altitude.

4. The system of claim 2, wherein the processor is deployed in the vehicle, and further comprising a first transceiver coupled to the portable electronic device for transmitting the first signal to the processor.

5. The system of claim 2, wherein the processor is deployed in the portable electronic device, and further comprising a second transceiver coupled to the vehicle for transmitting the second signal to the processor.

6. The system of claim 2, wherein the first signal and the second signal are temperature-compensated signals.

7. The system of claim 2, wherein the portable electronic device is a keyfob.

8. The system of claim 2, wherein the first pressure sensor is configured to generate the first signal and the second pressure sensor is configured to generate the second signal at substantially the same time.

9. A method for determining the difference in altitude between a portable electronic device and a vehicle, the method comprising the steps of:
sensing a first atmospheric pressure at the portable electronic device using a first pressure sensor;
determining a first pressure altitude based on the first atmospheric pressure;
sensing a second atmospheric pressure at the vehicle using a second pressure sensor; and
determining a second pressure altitude based on the second atmospheric pressure.

10. The method of claim 9, further comprising the step of determining the difference in altitude based upon the first pressure altitude and the second pressure altitude.

11. The method of claim 9, further comprising the step of generating a command in the portable electronic device to initiate activation of the first pressure sensor to sense the first atmospheric pressure and the second pressure sensor to sense the second atmospheric pressure.

12. The method of claim 9, wherein the steps of sensing a first atmospheric pressure and sensing a second atmospheric pressure further comprise sensing a first atmospheric pressure and sensing a second atmospheric pressure that are temperature-compensated.

13. The method of claim 9, wherein the steps of sensing a first atmospheric pressure and sensing a second atmospheric pressure further comprise sensing a first atmospheric pressure and sensing a second atmospheric pressure when the portable electronic device and the vehicle are at substantially the same altitude.

14. The method of claim 10, wherein the portable electronic device comprises a display and further comprising the step of displaying the difference in altitude on the display.

15. The method of claim 10, wherein the step of determining the difference in altitude further comprises compensating for the pressure altitude offset.

16. The method of claim 9, wherein the step of determining the difference in altitude further comprises determining the difference in altitude using a look-up table.

17. The method of claim 9, wherein the step of determining the difference in altitude further comprises determining the difference in altitude using at least one mathematical formula.

18. The method of claim 9, wherein the step of sensing a second atmospheric pressure further comprises sensing a second atmospheric pressure at substantially the same time as the first atmospheric pressure is sensed.

19. A system for locating a vehicle, the system including a keyfob, the system comprising:
a first pressure sensor coupled to the keyfob for generating a first signal indicative of the atmospheric pressure at the portable electronic device;
a second pressure sensor coupled to the vehicle for generating a second signal indicative of the atmospheric pressure at the vehicle; and
a processor coupled to the vehicle and configured to receive the first signal and to determine a first pressure altitude therefrom, and to receive the second signal and determine a second pressure altitude therefrom, and to determine a difference in altitude between the vehicle and the keyfob based upon the first pressure altitude and the second pressure altitude.

20. The system of claim 19, further comprising a user interface coupled to the vehicle configured to initiate activation of the first pressure sensor to generate the first signal, and the second pressure sensor to generate the second signal.
